(19) United States
(12) Patent Application Publication
(10) Pub. No.: US 2025/0256988 A1
(43) Pub. Date: Aug. 14, 2025

(54) Ultrasound-Assisted System To Efficiently Remove Particles from Fluid Streams

(71) Applicants: Justin Huang, The Woodlands, TX (US); Victoria Ou, The Woodlands, TX (US)

(72) Inventors: Justin Huang, The Woodlands, TX (US); Victoria Ou, The Woodlands, TX (US)

(21) Appl. No.: 18/442,079

(22) Filed: Feb. 14, 2024

(51) Int. Cl. C02F 1/36; B01D 21/28; C02F 101/32; C02F 101/34

(52) U.S. Cl. CPC C02F 1/36; B01D 21/283; C02F 2101/327; C02F 2101/34

(57) ABSTRACT

This invention introduces an innovative ultrasound-based system, specifically engineered for the effective interception and removal of particles, such as microplastics, from fluid flows. Central to its design is the strategic use of ultrasound technology to facilitate the aggregation of particles upstream of the ultrasound zone. This approach ensures the seamless passage of the fluid while effectively concentrating and isolating the particles for removal. A key feature of this system is the capability to adjust ultrasound frequencies, thereby optimizing the process of particle concentration reduction. Overall, the system presents a robust and eco-friendly solution for mitigating the environmental impact of microplastic pollution in wastewater and other fluid streams.

### FIELD OF THE INVENTION

This invention pertains to particle removal technologies within fluid systems, with a specialized focus on the extraction and management of microplastic contaminants in various aqueous environments. It represents a significant advancement in environmental conservation efforts, particularly in the treatment of wastewater. By addressing the pervasive and challenging issue of microplastic pollution, this invention not only contributes to the purification of water resources but also plays a crucial role in safeguarding aquatic ecosystems and, by extension, public health. Its application spans a range of contexts, from industrial wastewater management to ecological preservation, reflecting its versatility and relevance in the current environmental landscape.

### BACKGROUND OF THE INVENTION

Many fluids inadvertently contain unwanted particles, among which microplastics in wastewater are notably harmful, posing severe risks to both marine ecosystems and human health. Microplastics in natural environments lead to a multitude of detrimental effects. These include altering organisms' behavior, hindering marine species' growth and reproductive capabilities, and damaging their immune systems. Microplastics can penetrate and accumulate within the tissues of aquatic organisms, adversely affecting essential functions like metabolism and mobility. Moreover, these particles, laden with hydrocarbons, can induce genetic alterations, potentially leading to widespread ecological devastation.

Current strategies for extracting microplastics from water, such as membrane filtration, oxidation treatment, and coagulation/flocculation processes, are fraught with challenges, including health safety concerns, impracticality for large-scale application, and the high cost of necessary materials. Notably, Marey (“Effectiveness of chitosan as a natural coagulant in treating turbid waters” in Bionatura, 4(2), 856-860, 2019) identified significant health risks associated with common inorganic coagulants used in many water treatment facilities, such as those based on aluminum and iron, including potential neurological and digestive issues. Additionally, many of these prevalent methods are limited by constraints that impede their effectiveness.

Consequently, the need for an eco-friendly and efficient microplastic filtration method has become apparent, with ultrasonic treatment emerging as a viable solution.

Ultrasonic waves, with frequencies above 20 kHz, are generated when electric currents prompt certain crystalline materials within a transducer to expand and contract, converting electricity into mechanic vibration. The concept of particle agglomeration, typically seen in coagulation and flocculation, has been applied using ultrasound in various scientific domains. For instance, simulations by Ma et al., (“Numerical simulation of the red blood cell aggregation and deformation behaviors in ultrasonic field”, in Ultrasonics Sonochemistry, 38, 604-613. 2017) demonstrated the agglomeration of red blood cells in ultrasonic fields. More recently, Perera and Piyasena (“Acoustic focusing of microplastics in microfabricated and steel tube devices: An experimental study on the effects from particle size and medium density” in Separation and Purification Technology, 288(120649) 2022) explored the alignment and passage of microplastic particles in confined spaces using ultrasound.

This invention introduces a novel approach, distinct from existing methods, where microplastics are impeded or filtered out before reaching the ultrasound zone. In contrast to traditional practices where microplastics traverse the ultrasound zone and are collected downstream, our method accumulates these particles upstream. By clustering microplastic particles before they encounter the ultrasound zone, a higher concentration of microplastics can be achieved at a targeted location, significantly enhancing the efficiency of their removal.

### SUMMARY OF THE INVENTION

The invention utilizes ultrasound technology to selectively block particles in a fluid flow while maintaining the continuous passage of liquid. Ultrasound-emitting devices are affixed to the sides of the flow passage. By employing the appropriate ultrasound frequency, particles aggregate before the ultrasound zone, enabling the liquid to flow through with minimal hindrance. This mechanism ensures efficient particle blocking without obstructing the fluid flow.

### BRIEF DESCRIPTION OF THE DRAWINGS

The advantages of the present invention may be better understood by referring to the following detailed description and the attached drawings.

FIG. 1 shows microplastic type information and microscope view of microplastic particle size

FIG. 2 shows experimental setup to demonstrate the effectiveness of the invention.

FIG. 3 shows the experiment results demonstrating the effectiveness of the invention.

### DETAILED DESCRIPTION

This section outlines the experimental procedures used to demonstrate the invention. It is to be noted that the invention is not limited to the described methods.

### Step 1: Preparation of Microplastic Samples

Three types of microplastic samples are prepared.
Polyethylene (PE) samples were prepared by sanding a broken food container lid with 60-grit sandpaper and collecting the resultant particles.
Polyurethane (PU) samples were produced by cutting foam earplugs with scissors.
Polystyrene (PS) samples, obtained from Cospheric, were used as received.

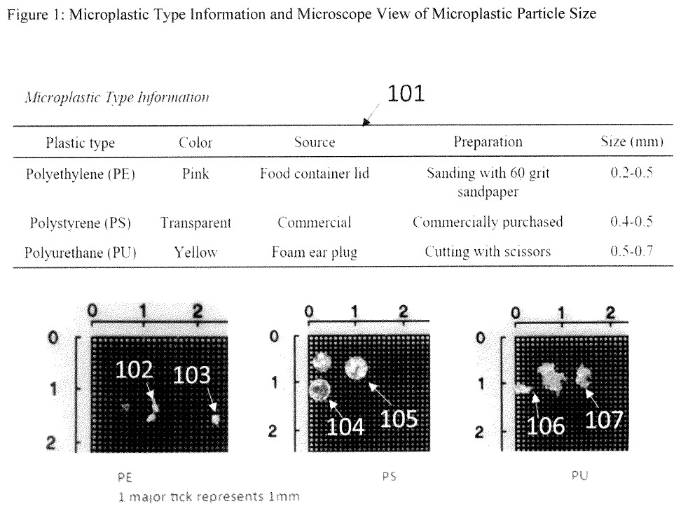

For each type of microplastic, detailed specifications are provided in FIG. 1, table 100. Particle size verification was conducted using a digital microscope and AMCap software, with pictures of particles under scale shown in FIG. 1. 101 and 102 show images of two PE particles. 103 and 104 show images of two PU particles. 105 and 106 show images of two PS particles. The microplastics were then mixed in a beaker with 80 mL of reverse osmosis water, to which laundry detergent was added to a final concentration of 0.5%. For visibility, yellow food coloring was mixed into the polystyrene sample.

### Step 2: Construction of Microplastic Filtration System

Stainless steel tubes of 9.6 mm inner diameter were sectioned into lengths of 55 mm, 60 mm, and 90 mm. Piezoelectric transducers, with resonant frequency of 1 MHz, were affixed to each tube with epoxy glue. A 0.74 MHz transducer was used specifically for the 90 mm tube. Silicon tubing of 10 mm inner diameter was attached to both ends of each steel tube. In two-stage experiments, a 1-cm-long silicon tubing segment connected two steel sections. The same construction process was repeated for a scaled-up model using steel tubes of 21 mm inner diameter.

### Step 3: Microplastic Separation Process

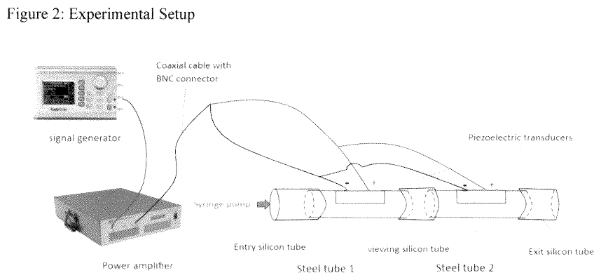

An ultrasound generator was assembled by connecting a signal generator and power amplifier using a coaxial cable. The output cable from the amplifier was split into positive and negative electrodes, which were soldered to the transducers and shielded with Faraday tape. The syringe pump, filled with the 80 mL microplastic sample and a rare earth magnet, was connected to the entry silicone tube of the filtration system and laid flat on a magnetic stirrer. The filtration system was then filled with reverse osmosis water from the opposite end before the ultrasound activation. Upon activation, the microplastic solution was pushed into the filtration system at various rates. A collection container was placed under the exit silicon tube to gather the filtered water, and top-angle photographs were taken to analyze particle concentrations. Before and after filtration images were used to calculate the filtration efficiencies. The experimental setup is illustrated in FIG. 2.

### Results

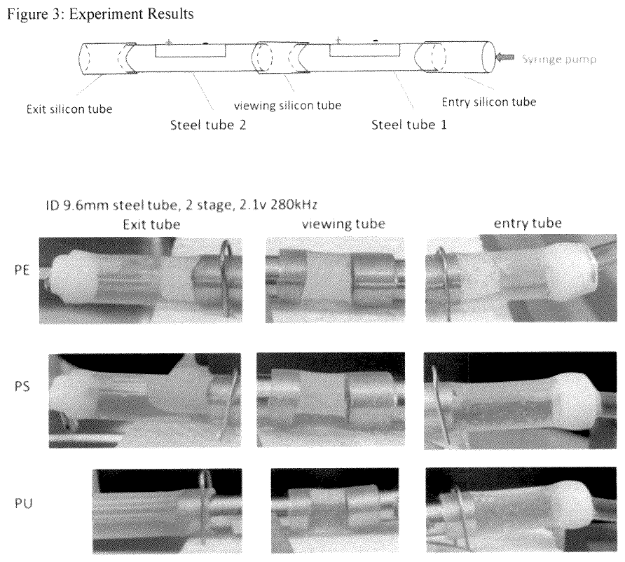

As illustrated in FIG. 3, upon activation of specific-frequency ultrasonic waves, an acoustic filtering effect occurred, preventing microplastics from entering the acoustic field in the steel tube, resulting in their aggregation in the entry tube and producing microplastic-free water at the exit.

The tested plastic types included polyethylene (PE), polyurethane (PU), and polystyrene (PS). The device achieved filtering efficiencies of 95.15% for PE, 95.84% for PU, and 98.13% for PS, with denser plastics like PS being more effectively filtered. Various frequencies, applied voltages, and flow rates were tested for filtering efficiency. For the above-shown 6 cm-steel tube two-stage filtering setup, a combination of 280 KHz, 2.1 volts, and 20 millimeters per minute was used for the experiments.

1. A system designed to utilize ultrasound technology for blocking particles within a fluid flow, characterized by its ability to maintain uninterrupted fluid passage while reducing the concentration of particles post-ultrasound zone.

2. The system of claim 1, further comprises an adjustable ultrasound frequency and applied voltage mechanism, facilitating the enhancement of particle removal effectiveness within the fluid flow.

3. The system of claim 1, wherein the length and cross-sectional diameter of the fluid pathway are modifiable, serves to augment the system's overall filtering efficiency.
